(19) United States
(12) Patent Application Publication
(10) Pub. No.: US 2004/0174331 A1
(43) Pub. Date: Sep. 9, 2004

(54) Backlight module for a data input device

(75) Inventors: Chih-Wen Su, Chung-Ho City (TW); Chih-Long Lo, Taipei City (TW)

Correspondence Address: Finnegan, Henderson, Farabow,, Garrett & Dunner, L.L.P., 1300 I Street, N.W., Washington, DC, 20005-3315, US

(73) Assignee: BEHAVIOR TECH COMPUTER CORP.

(21) Appl. No.: 10/609,593

(22) Filed: Jul. 1, 2003

(30) Foreign Application Priority Data
Mar. 7, 2003 (TW) 092203509

(51) Int. Cl. G09G 3/36

(52) U.S. Cl. 345/102

(57) ABSTRACT

A backlight module is provided for a data input device having at least one element to be illuminated. The backlight module includes a light guide panel, a light source, and a reflective layer. The light guide panel is disposed inside the data input device below the element, and includes a pair of opposed end faces, a bottom face interconnecting the end faces, and a top face opposite to the bottom face and interconnecting the end faces. The bottom face has a plurality of light deflection parts. The top face has a light emanating pattern adapted to correspond to the element. The light source is provided on at least one of the end faces. The reflective layer covers the bottom face.

### CROSS-REFERENCE TO RELATED APPLICATION

This application claims priority of Taiwanese application No. 092203509, filed on Mar. 7, 2003.

### BACKGROUND OF THE INVENTION

1. Field of the Invention

The invention relates to a backlight module, more particularly to a backlight module for a data input device having at least one element to be illuminated.

2. Description of the Related Art

Referring to FIG. 1, a conventional keyboard 9 disclosed in U.S. Patent Application No. 2002/0105795 includes a plurality of key elements 91, a circuit board 92, a light guide panel 93 disposed under the key elements 91, and at least one LED (light emitting diode) light source 94 disposed beside the light guide panel 93 and connected electrically to the circuit board 92. The light emitted from the light source 94 is guided by the light guide panel 93 toward the key elements 91 so as to result in a backlight effect. Therefore, the keyboard 9 can be operated in an environment having a low level of ambient light.

A conventional method for preparing the aforesaid light guide panel 93 is conducted by injection molding a light guide panel body having high transmittance and smooth surfaces, and by forming a plurality of light deflection points of different sizes and densities by screen printing of a highly reflective material (such as, TiO₂) beneath the body. Since the method includes two separate processing steps (i.e., the injection-molding and the screen-printing), it is relative complicated. Therefore, the conventional method takes much time to conduct, and involves high equipment costs.

In order to overcome the shortcomings of the aforesaid method, another conventional method has been proposed heretofore. A light guide panel of a non-screen printing type is made by incorporating a minor amount of particulate material (such as, MMA) into a light guide panel body during the integral forming thereof. However, it is difficult to control the distribution and the light deflection of the particulate material within the light guide panel body.

### SUMMARY OF THE INVENTION

Therefore, it is an object of the present invention to provide a backlight module for a data input device having at least one element to be illuminated. The backlight module includes a light guide panel, a light source, and a reflective layer. The light guide panel is disposed inside the data input device below the element, and includes a pair of opposed end faces, a bottom face interconnecting the end faces, and a top face opposite to the bottom face and interconnecting the end faces. The bottom face has a plurality of light deflection parts. The top face has a light emanating pattern adapted to correspond to the element. The light source is provided on at least one of the end faces. The reflective layer covers the bottom face.

It is another object of the present invention to provide a data input device including a body having at least one element to be illuminated and a backlight module. The backlight module has a light guide panel, a light source, and a reflective layer. The light guide panel is disposed inside the body below the element, and includes a pair of opposed end faces, a bottom face interconnecting the end faces, and a top face opposite to the bottom face and interconnecting the end faces. The bottom face has a plurality of light deflection parts. The top face has a light emanating pattern corresponding to the element so as to illuminate the element. The light source is provided on at least one of the end faces. The reflective layer covers the bottom face.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a keyboard that incorporates a conventional backlight module;

FIG. 2 is a perspective view of a keyboard that incorporates the first preferred embodiment of the backlight module according to this invention;

FIG. 3 is an exploded perspective view of the first preferred embodiment;

FIG. 4 is a perspective view of the first preferred embodiment;

FIG. 5 is a fragmentary schematic view of the first preferred embodiment;

FIG. 6 is a fragmentary schematic partly sectional view of the keyboard of FIG. 2;

FIG. 7 is a perspective view of the second preferred embodiment of the backlight module according to this invention;

FIG. 8 is a fragmentary bottom view of the second preferred embodiment;

FIG. 9 is a fragmentary bottom view of the third preferred embodiment of the backlight module according to this invention;

FIG. 10 is a perspective view of a keyboard that incorporates the fourth preferred embodiment of the backlight module according to this invention; and

FIG. 11 is a fragmentary schematic sectional view of the keyboard of FIG. 10.

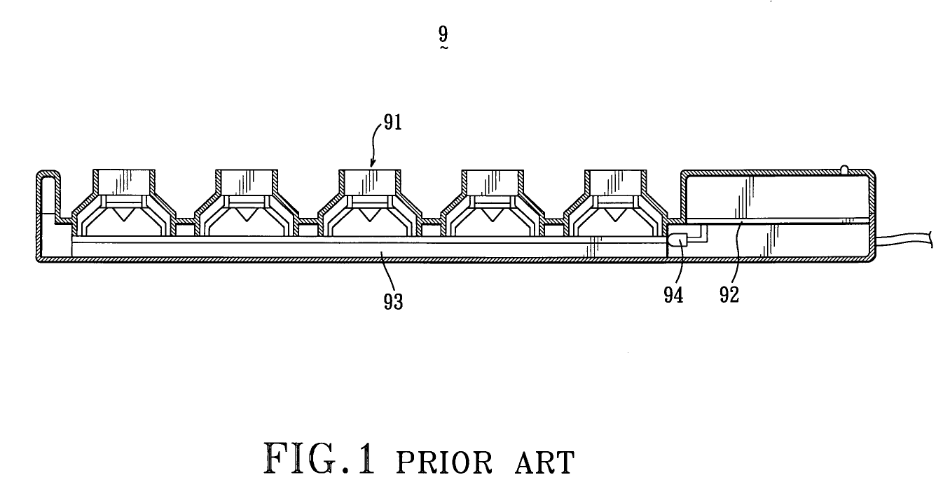

### DETAILED DESCRIPTION OF THE PREFERRED EMBODIMENT

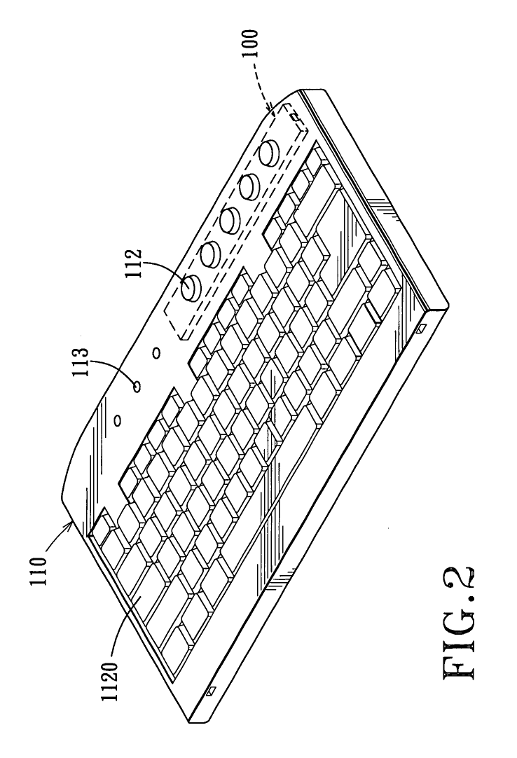

Referring to FIGS. 2 and 6, the first preferred embodiment of a backlight module 100 according to this invention is shown to be incorporated into a keyboard 110. The keyboard 110 is provided with a plurality of standard keys 1120 and a plurality of functional keys 112. The backlight module 100 is mounted in the keyboard 110 and corresponds to the functional keys 112. As best shown in FIG. 6, the backlight module 100 produces backlight directed upward for illuminating the functional keys 112. Although the backlight module 100 is illustrated for illuminating the functional keys 112 in this preferred embodiment, it can also be used for illuminating the indicators 113 of the keyboard 110. Furthermore, the backlight module 100 can also be applied for illuminating the display portion of other devices, such as a liquid crystal display, a monitor, a mobile phone, and other electronic devices.

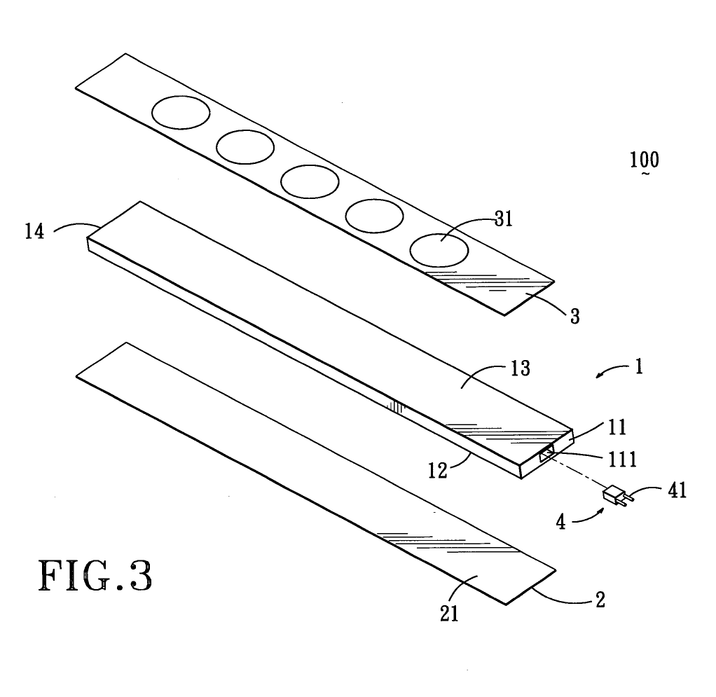

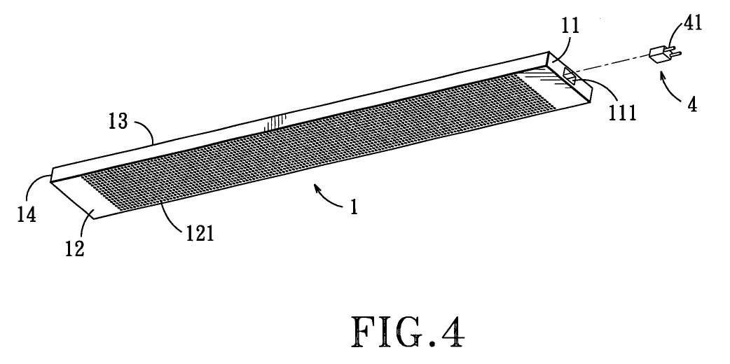

Referring to FIGS. 2 to 5, the backlight module 100 includes a light guide panel 1, a light source 4, a reflective layer 2, and a pattern layer 3. The light guide panel 1 is disposed inside the keyboard 110 below the functional keys 112, and includes a pair of opposed end faces 11, 14, a bottom face 12 interconnecting the end faces 11, 14, and a top face 13 opposite to the bottom face 12 and interconnecting the end faces 11, 14. The bottom face 12 has a plurality of light deflection parts 121. The light source 4 is provided at the end face 11. The reflective layer 2 covers the bottom face 12, and is provided with a reflective membrane 21 for reflecting the light that reaches the bottom face 12 of the light guide panel 1 back into the light guide panel 1 so as to enhance the efficiency of illumination. The patterned layer 3 is provided on the top face 13 of the light guide panel 1, and is formed with a light emanating pattern having a plurality of light transmitting parts 31 substantially aligned with the functional keys 112 so as to transmit light through the light transmitting parts 31 and to provide the functional keys 112 with a backlight effect. The light source 4 can be suitably selected from a luminescence diode, a cold cathode fluorescent lamp, a hot cathode fluorescent lamp, an electroluminescent sheet, or any other suitable device capable of generating light. The design, the construction and the function of the light source 4 are well known in the art, and thus will not be further described herein.

Although, in the preferred embodiment, the light guide panel 1 is made of polycarbonate, other materials such as acrylic material or other suitable light-transmitting materials can be used. The light guide panel 1 is formed in a rectangular shape. The end face 11 of the light guide panel 1 is provided with a recess 111 for mounting the light source 4 therein. The luminescence diode is used as the light source 4 in the preferred embodiment. The light source 4 has two pins 41 which are electrically connected to a circuit board (not shown) mounted within the keyboard 110. More than one light source 4 can be mounted on the end face 11, if desired. Additionally, the light source 4 can be mounted directly on the end face 11, or on a proper location of the top face of the light guide panel 1.

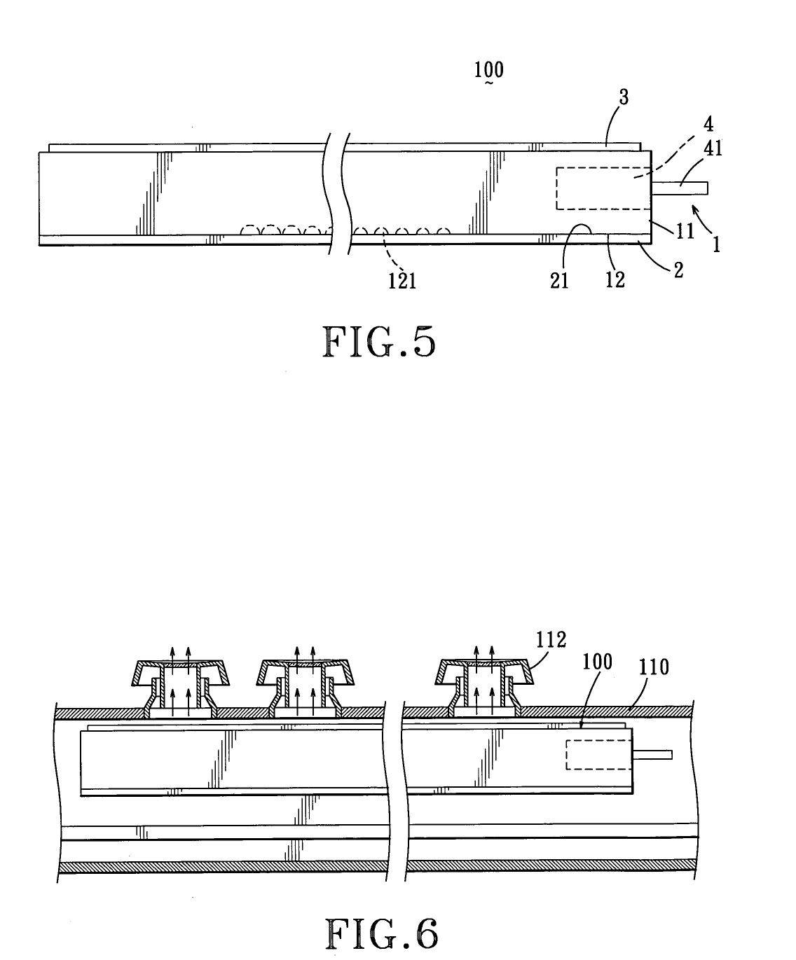

Specifically referring to FIG. 5, as described above, the bottom face 12 of the light guide panel 1 is provided with a plurality of light deflection parts 121 for reflecting light toward the top face 13 of the light guide panel 1. In the preferred embodiment, light deflection parts 121 are configured as indentations, which increase in density from the light source 4 in a direction away from the light source 4 (i.e., in a direction from the end face 11 toward the end face 14), and which increase in size from the light source 4 in a direction away from the light source 4 so that the illuminance distribution is substantially identical on the top face 13 of the light guide panel 1. The light guide panel 1 with the light deflection parts 121 can be formed using a mold having a corresponding configuration therefor. Additionally, the light deflection parts 121 can be similarly formed by chemical etching, laser processing, or other suitable techniques.

Furthermore, in the preferred embodiment, each of the light deflection parts 121 is formed in a shape of semi-spherical indentation. Other suitable shapes, such as a cubic shape, a pyramidal shape or a conical shape, can be used in the present invention, as desired. The shape, size, spacing and arrangement of the light deflection parts 121 can be adjusted depending on various factors, such as the material, shape, thickness and the area of the light guide panel 1, as well as the number of the light source 4.

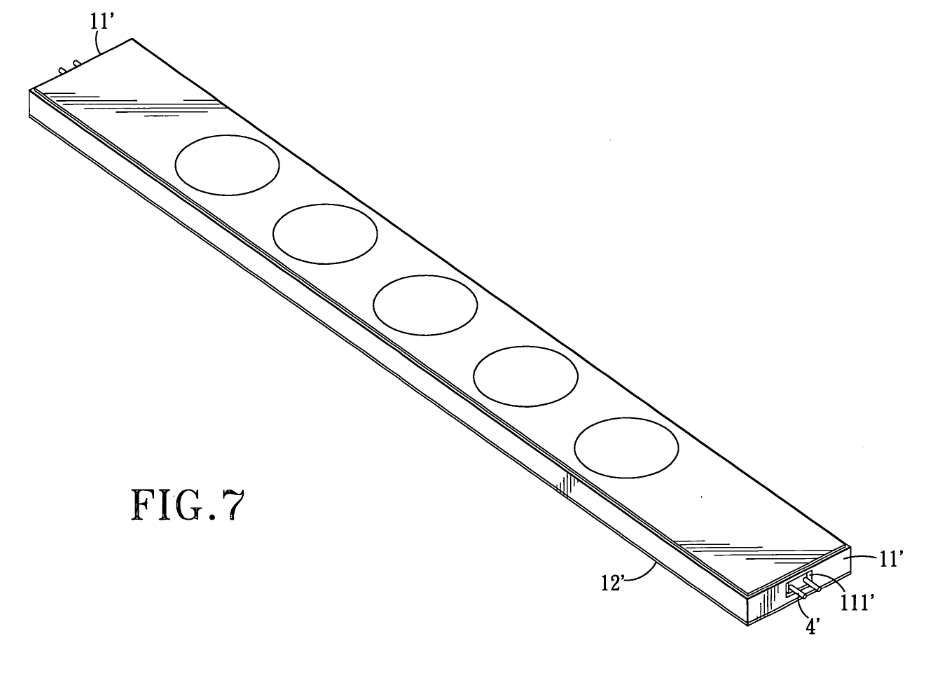

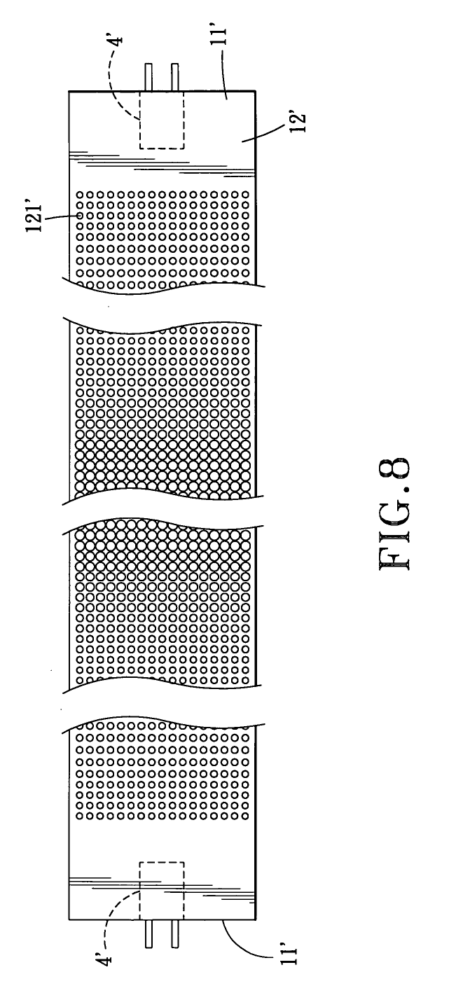

Referring to FIGS. 7 and 8, the second preferred embodiment of this invention is similar to the first preferred embodiment in structure, except for the following. The light source 4′ is provided within the recess 111′ in each of the end faces 11′. The indentations of the light deflection parts 121′ increase in size and density from each light source 4′ toward a middle of the bottom face 12′.

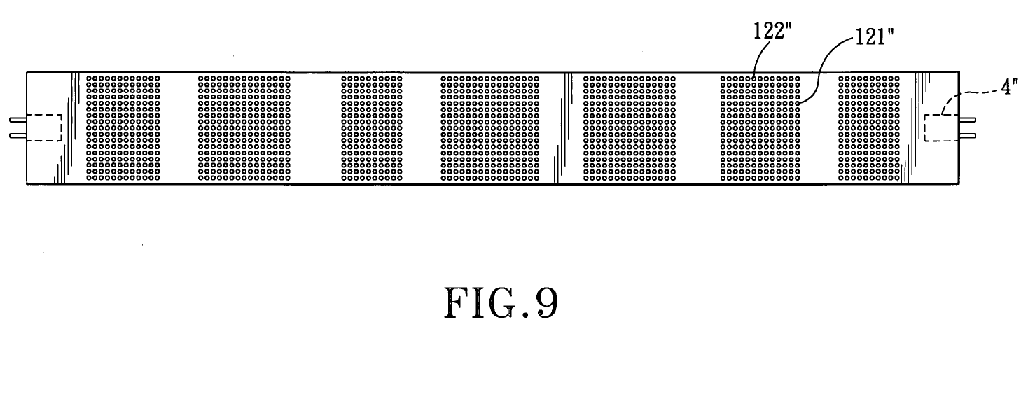

Referring to FIG. 9, the third preferred embodiment of this invention is similar to the second preferred embodiment in structure, except for the following. The indentations of the light deflection parts 121″ are arranged in a plurality of groups 122″. The groups 122″ of the indentations are spaced apart from each other. The shape, size, spacing and arrangement of the indentations of each of the groups 122″ can be designed according to the requirement of the light source 4″ and other intended purposes.

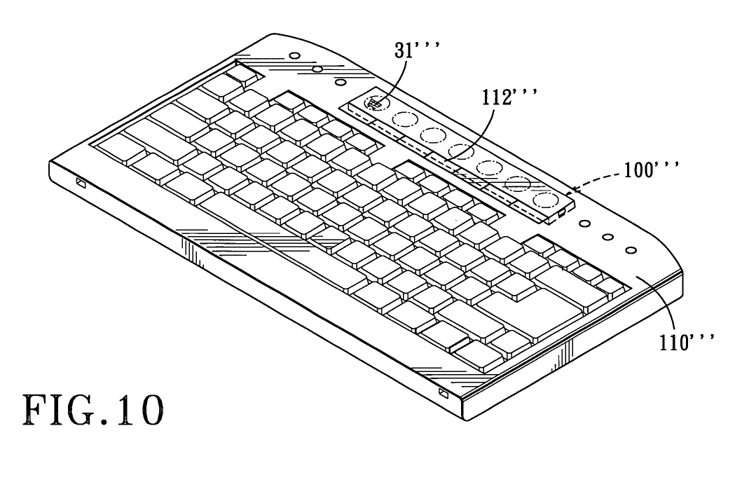

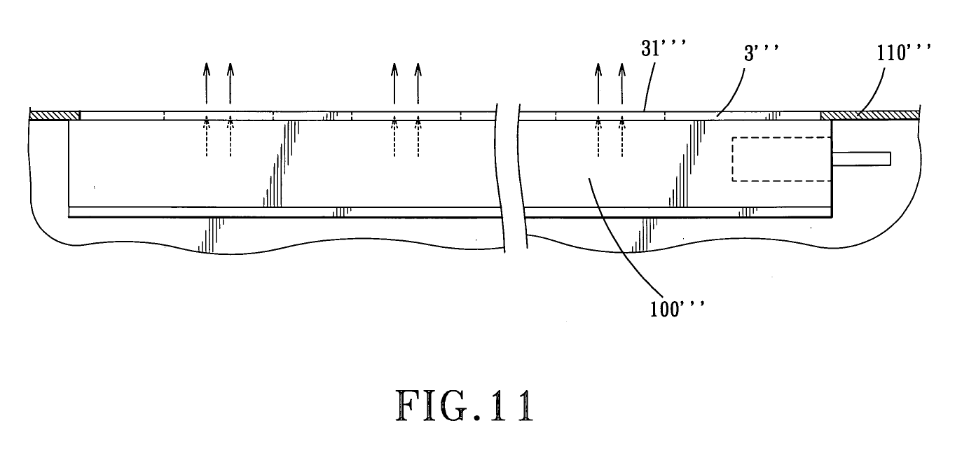

Referring to FIGS. 10 and 11, the fourth preferred embodiment of this invention is similar to the first preferred embodiment in structure, except for the following. The backlight module 100′″ is disposed within the keyboard 110′″, and is arranged in front of the functional keys 112′″. The light emanating pattern 3′″ of the backlight module 100′″ is level with the top faces of the functional keys 112′″. The light transmitting parts 31′″ of the light emanating pattern 3′″, are aligned with the functional keys 112′″, respectively.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A backlight module for a data input device having at least one element to be illuminated, comprising:
a light guide panel adapted to be disposed inside the data input device below the element, said light guide panel including a pair of opposed end faces, a bottom face interconnecting said end faces, and a top face opposite to said bottom face and interconnecting said end faces, said bottom face having a plurality of light deflection parts, said top face having a light emanating pattern adapted to correspond to the element;
a light source provided on at least one of said end faces; and
a reflective layer covering said bottom face.

2. The backlight module as claimed in claim 1, wherein said light deflection parts are configured as indentations.

3. The backlight module as claimed in claim 2, wherein each of said indentations has a shape selected from a group consisting of a semi-sphere, a cube, a pyramid, and a cone.

4. The backlight module as claimed in claim 2, wherein said indentations increase in density from said light source in a direction away from said light source.

5. The backlight module as claimed in claim 2, wherein said indentations increase in size from said light source in a direction away from said light source.

6. The backlight module as claimed in claim 2, wherein said light source is provided on each of said end faces, said indentations increasing in size and density from each said light source toward a middle of said bottom face.

7. The backlight module as claimed in claim 2, wherein said indentations are arranged in a plurality of groups, said groups of said indentations being spaced apart from each other.

8. The backlight module as claimed in claim 1, wherein said top face is provided with a patterned layer to form said light emanating pattern, said light emanating pattern having a plurality of light transmitting parts.

9. A data input device, comprising
a body having at least one element to be illuminated, and
a backlight module which includes:
a light guide panel disposed inside said body below said element and including a pair of opposed end faces, a bottom face interconnecting said end faces, and a top face opposite to said bottom face and interconnecting said end faces, said bottom face having a plurality of light deflection parts, said top face having a light emanating pattern corresponding to said element so as to illuminate said element;
a light source provided on at least one of said end faces; and
a reflective layer covering said bottom face.

10. The data input device as claimed in claim 9, wherein said light deflection parts are configured as indentations.

11. The data input device as claimed in claim 10, wherein each of said indentations has a shape selected from a group consisting of a semi-sphere, a cube, a pyramid, and a cone.

12. The data input device as claimed in claim 10, wherein said indentations increase in density from said light source in a direction away from said light source.

13. The data input device as claimed in claim 10, wherein said indentations increase in size from said light source in a direction away from said light source.

14. The data input device as claimed in claim 10, wherein said light source is provided on each of said end faces, said indentations increasing in size and density from each said light source toward a middle of said bottom face.

15. The data input device as claimed in claim 10, wherein said indentations are arranged in a plurality of groups, said groups of said indentations being spaced apart from each other.

16. The data input device as claimed in claim 9, wherein said top face is provided with a patterned layer to form said light emanating pattern.

17. The data input device as claimed in claim 9, wherein said body has a plurality of said elements, said light emanating pattern having a plurality of light transmitting parts substantially aligned with said elements.

18. The data input device as claimed in claim 17, wherein said elements are configured as keys.
